(19) United States
(12) Patent Application Publication
(10) Pub. No.: US 2017/0236040 A1
(43) Pub. Date: Aug. 17, 2017

(54) IMAGE QUALITY ADJUSTMENT APPARATUS, IMAGE QUALITY ADJUSTMENT METHOD, AND NON-TRANSITORY COMPUTER READABLE MEDIUM

(71) Applicant: FUJI XEROX CO., LTD., Tokyo (JP)

(72) Inventors: Kiyoshi UNE, Kanagawa (JP); Takashi NAKAJIMA, Kanagawa (JP); Takaya NAGASAKI, Kanagawa (JP); Seiji SHIRAKI, Kanagawa (JP); Shinji HANAOKA, Kanagawa (JP); Ryosuke TSUJI, Kanagawa (JP)

(73) Assignee: FUJI XEROX CO., LTD., Tokyo (JP)

(21) Appl. No.: 15/217,768

(22) Filed: Jul. 22, 2016

(30) Foreign Application Priority Data
Feb. 16, 2016 (JP) 2016-026600

(51) Int. Cl. G06K 15/02

(52) U.S. Cl. CPC G06K 15/188; G06K 15/1807

(57) ABSTRACT

An image quality adjustment apparatus includes an adjustment unit and an order controller. The adjustment unit sequentially receives instructions of adjustment details for adjustment processes of multiple of types for adjusting image quality, and sequentially performs the adjustment processes on an image. The order controller presents, in accordance with priority ranks that have been associated in advance with characteristics of an image to be processed, operation screens for receiving instruction operations for the adjustment details.

### CROSS-REFERENCE TO RELATED APPLICATIONS

This application is based on and claims priority under 35 USC 119 from Japanese Patent Application No. 2016-026600 filed Feb. 16, 2016.

### BACKGROUND

(i) Technical Field

The present invention relates to an image quality adjustment apparatus, an image quality adjustment method, and a non-transitory computer readable medium.

(ii) Related Art

Hitherto there may have been a case where an adjustment function through which image quality such as the colors or contrast of an image represented by image data is adjusted in accordance with an instruction indicated by adjustment details input by a user is installed in, for example, a printer driver.

### SUMMARY

According to an aspect of the invention, there is provided an image quality adjustment apparatus including an adjustment unit and an order controller. The adjustment unit sequentially receives instructions of adjustment details for adjustment processes of multiple of types for adjusting image quality, and sequentially performs the adjustment processes on an image. The order controller presents, in accordance with priority ranks that have been associated in advance with characteristics of an image to be processed, operation screens for receiving instruction operations for the adjustment details.

### BRIEF DESCRIPTION OF THE DRAWINGS

An exemplary embodiment of the present invention will be described in detail based on the following figures, wherein:

FIG. 1 is a diagram illustrating a print system in which an exemplary embodiment according to the present invention is installed;

FIG. 2 is a diagram illustrating a hardware configuration of a personal computer;

FIG. 3 is a functional block diagram illustrating a functional configuration of a print system;

FIG. 4 is a functional block diagram illustrating a functional configuration of an exemplary embodiment of an image quality adjustment apparatus according to the present exemplary embodiment of the present invention;

FIG. 5 is a diagram illustrating selection of an image portion whose characteristics are to be analyzed;

FIG. 6 is a diagram illustrating an example of a priority-rank database;

FIG. 7 is a diagram illustrating an input screen for color balance adjustment;

FIG. 8 is a diagram illustrating an input screen for screen selection;

FIG. 9 is a diagram illustrating an input screen for brightness adjustment;

FIG. 10 is a diagram illustrating an input screen for profile selection;

FIG. 11 is a diagram illustrating an input screen for gamma correction;

FIG. 12 is a diagram illustrating an input screen for contrast adjustment;

FIG. 13 is a diagram illustrating an input screen for chroma adjustment;

FIG. 14 is a diagram illustrating an example of an appropriate order of adjustment processes;

FIG. 15 is a graph illustrating an example of tone characteristics in a screen pattern having a low number of lines;

FIG. 16 is a graph illustrating an example of tone characteristics in a screen pattern having a high number of lines;

FIG. 17 is a diagram illustrating a first example of an operation screen according to the exemplary embodiment of the present invention; and

FIG. 18 is a diagram illustrating a second example of the operation screen according to the exemplary embodiment of the present invention.

### DETAILED DESCRIPTION

An exemplary embodiment of the present invention will be described in the following with reference to the drawings.

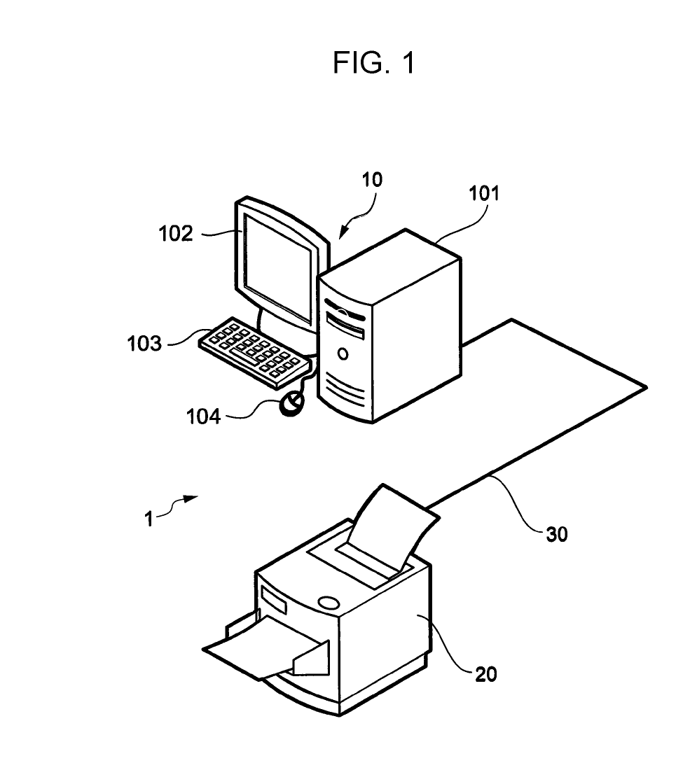

FIG. 1 is a diagram illustrating a print system 1 in which the exemplary embodiment of the present invention is installed.

The print system 1 has a configuration in which a personal computer 10 and a printer 20 are connected via a connection cable 30. A document image generated or edited by the personal computer 10 is then output by the printer 20. This document image includes characters (text), an illustration, a photo, and the like as structural elements.

When seen from the outside, the personal computer 10 has a main body 101, a display 102, a keyboard 103, and a mouse 104.

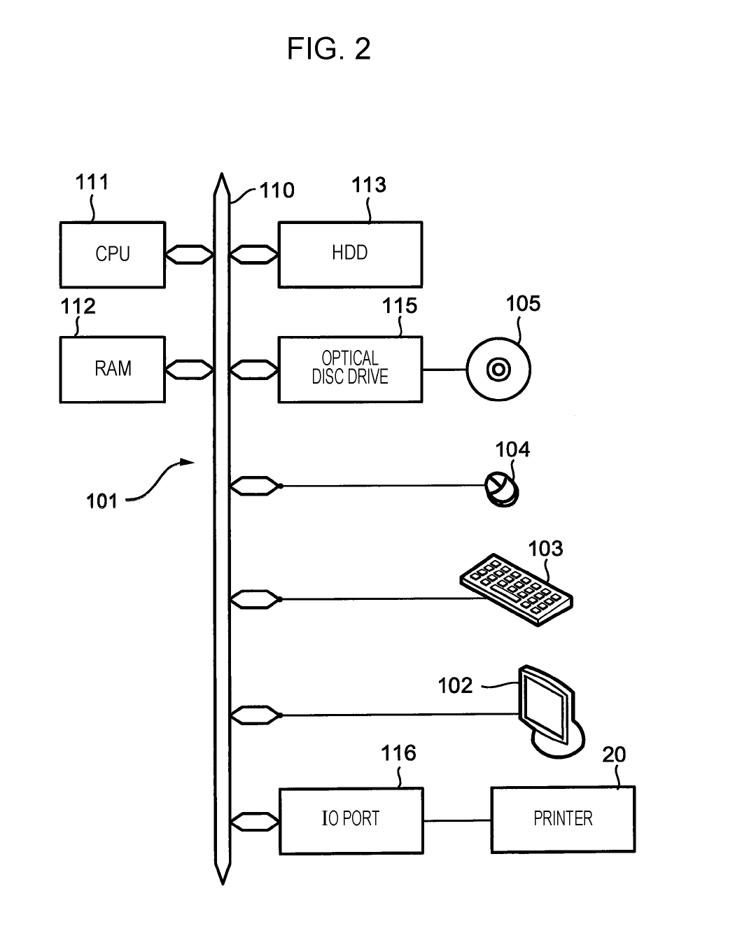

FIG. 2 is a diagram illustrating a hardware configuration of the personal computer 10.

The main body 101 of the personal computer 10 includes a central processing unit (CPU) 111, a random-access memory (RAM) 112, a hard disk drive (HDD) 113, an optical disc drive 115, and an input-output (IO) port 116, which are connected with each other via a bus 110.

In addition, the display 102, the keyboard 103, and the mouse 104 illustrated also in FIG. 1 are connected to the main body 101 via the bus 110, and the printer 20 illustrated also in FIG. 1 is connected to the IO port 116 via the connection cable 30, not illustrated.

An optical disc 105 on which programs are recorded are inserted into the optical disc drive 115, and the optical disc 105 is accessed by the optical disc drive 115. The programs stored on the optical disc 105 are loaded into the main body 101 by the optical disc drive 115 accessing the programs, and are installed in the HDD 113. The installed programs are then loaded into the RAM 112 and executed by the CPU 111, and as a result the personal computer 10 operates as various types of device.

In the present exemplary embodiment, an exemplary embodiment of an image quality adjustment program is stored on the optical disc 105. The personal computer 10 operates as an exemplary embodiment of an image quality adjustment apparatus by executing the image quality adjustment program, which is installed in the personal computer 10.

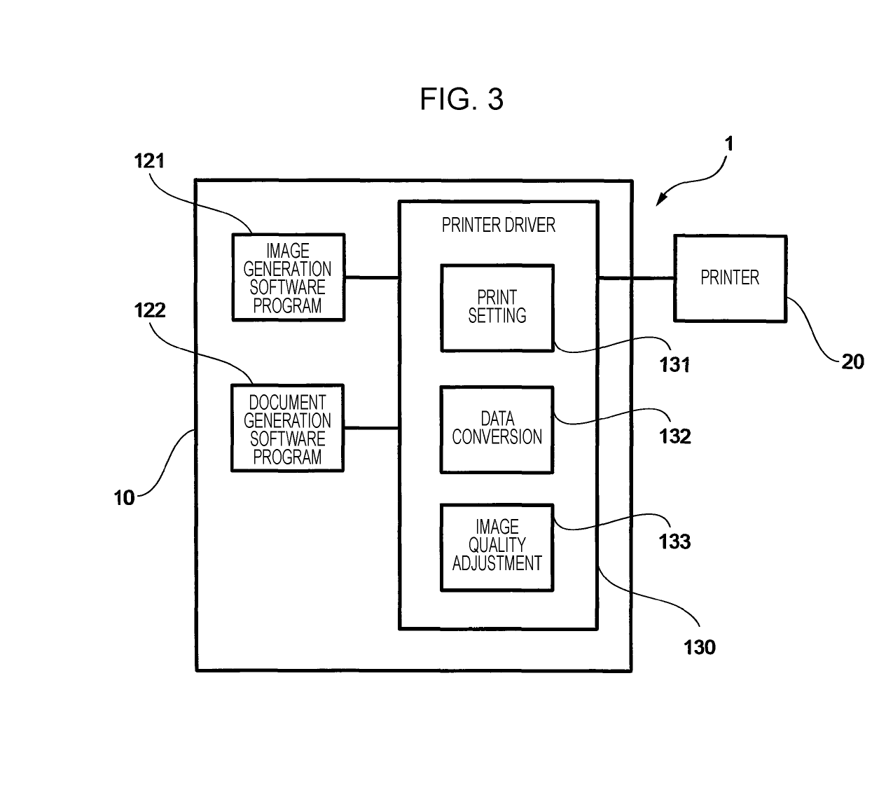

FIG. 3 is a functional block diagram illustrating a functional configuration of the print system 1.

The print system 1 functionally has a configuration in which the personal computer 10 is also connected to the printer 20.

An image generation software program 121 and a document generation software program 122 are installed in the personal computer 10, and the above-described document image is generated by a user operating these software programs.

To print the document image generated in this manner using the printer 20, a printer driver 130 is installed in the personal computer 10. A print setting function 131, a data conversion function 132, and an image quality adjustment function 133 are installed in the printer driver 130. Note that the present exemplary embodiment will be described in the following supposing that functions serving as an exemplary embodiment of the image quality adjustment apparatus are installed in the printer driver 130. However, the functions serving as the exemplary embodiment of the image quality adjustment apparatus may also be installed in the image generation software program 121 and the document generation software program 122.

The print setting function 131 is a function for setting the number of paper sheets to be printed, the type of paper sheet, and the like.

The data conversion function 132 is a function for converting, into image data in a format appropriate for printing performed by the printer 20, image data of a document image generated by the image generation software program 121 and the document generation software program 122.

The image quality adjustment function 133 is a function for adjusting the image quality of a document image. The image quality adjustment function 133 is a function serving as an exemplary embodiment of the image quality adjustment apparatus according to the present exemplary embodiment of the present invention.

Suppose that an exemplary embodiment of the image quality adjustment apparatus is realized in the personal computer 10 by executing the image quality adjustment function 133, and the image quality adjustment apparatus will be described in detail in the following.

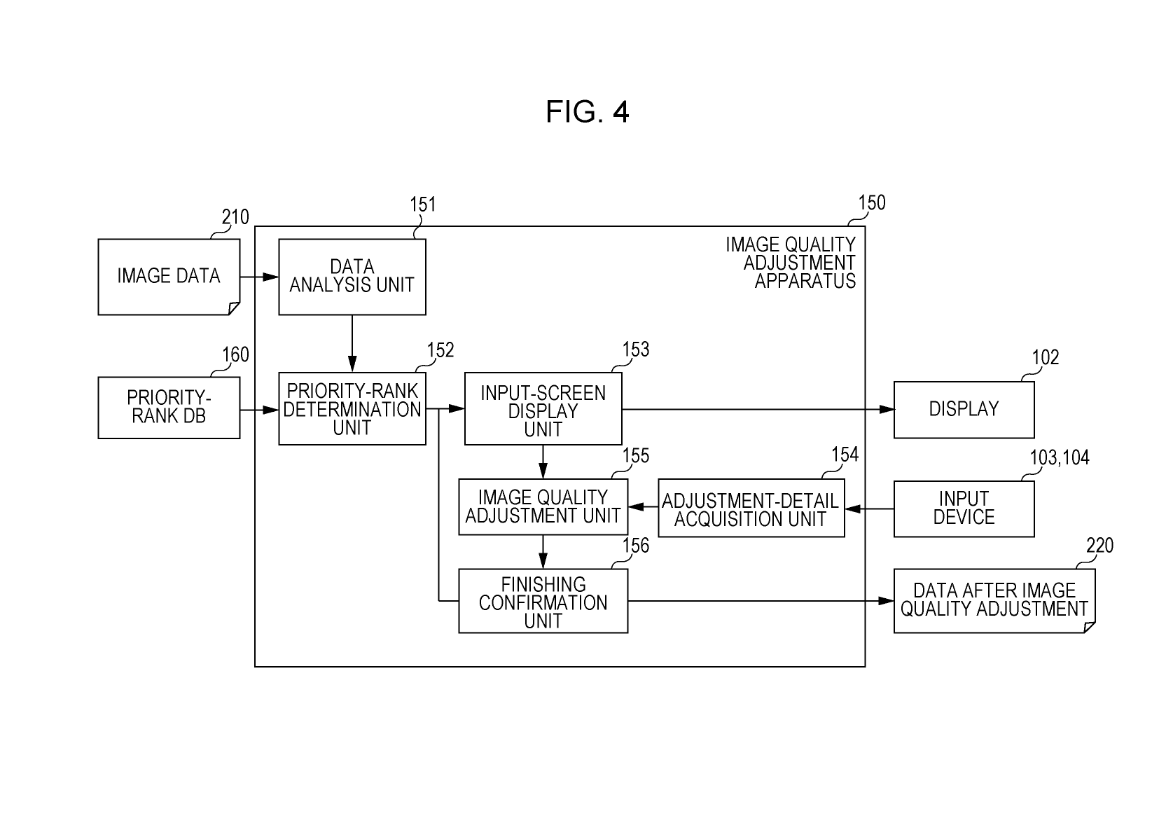

FIG. 4 is a functional block diagram illustrating a functional configuration of an exemplary embodiment of an image quality adjustment apparatus 150 according to the present exemplary embodiment of the present invention.

The image quality adjustment apparatus 150 includes a data analysis unit 151, a priority-rank determination unit 152, an input-screen display unit 153, an adjustment-detail acquisition unit 154, an image quality adjustment unit 155, and a finishing confirmation unit 156.

The data analysis unit 151 receives image data 210 representing a document image generated by the image generation software program 121 and the document generation software program 122, and analyzes characteristics of the document image represented by the image data 210. The brightness and chroma of the document image are analyzed as an example of characteristics of the document image in the present exemplary embodiment. In addition, in the present exemplary embodiment, the entire document image is treated as an analysis target, and the characteristics of the document image are analyzed.

Here, as another example in contrast to the present exemplary embodiment, an example will be described in which a portion of an image is selected to be analyzed, and the characteristics of the image are analyzed.

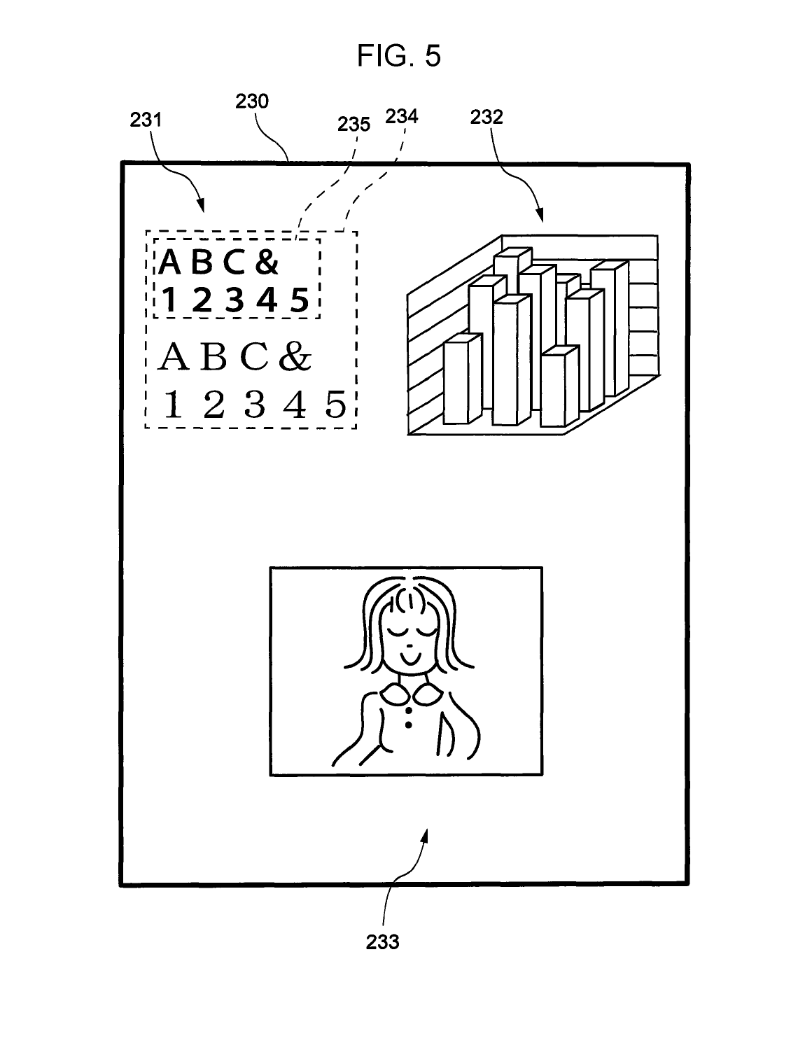

FIG. 5 is a diagram illustrating selection of an image portion whose characteristics are to be analyzed.

FIG. 5 illustrates a document image 230 as an example, and the document image 230 includes characters 231, a graph 232, and a photo 233 as structural elements in this example.

In FIG. 5, image portions 234 and 235 selected as analysis targets are indicated by dotted lines in the document image 230.

In a first example of selection of an image portion to be analyzed, one of the structural elements is selected through for example a click operation. As a result, the selected structural element, the image portion 234, is to be analyzed.

In a second example of selection of an image portion to be analyzed, any region in the document image 230 is selected through for example a drag-and-drop operation. As a result, the selected region, the image portion 235, is to be analyzed.

Returning back to FIG. 4, description of the present exemplary embodiment will be continued.

The priority-rank determination unit 152 determines priority ranks of adjustment processes of multiple types on the basis of the characteristics of the document image analyzed by the data analysis unit 151. Priority ranks are prestored in the HDD 113 or on the optical disc 105 as a priority-rank database 160. The priority ranks of the adjustment processes are determined by verifying the characteristics of the image acquired as a result of the analysis against the priority-rank database 160. Here, an example of the priority-rank database 160 will be described.

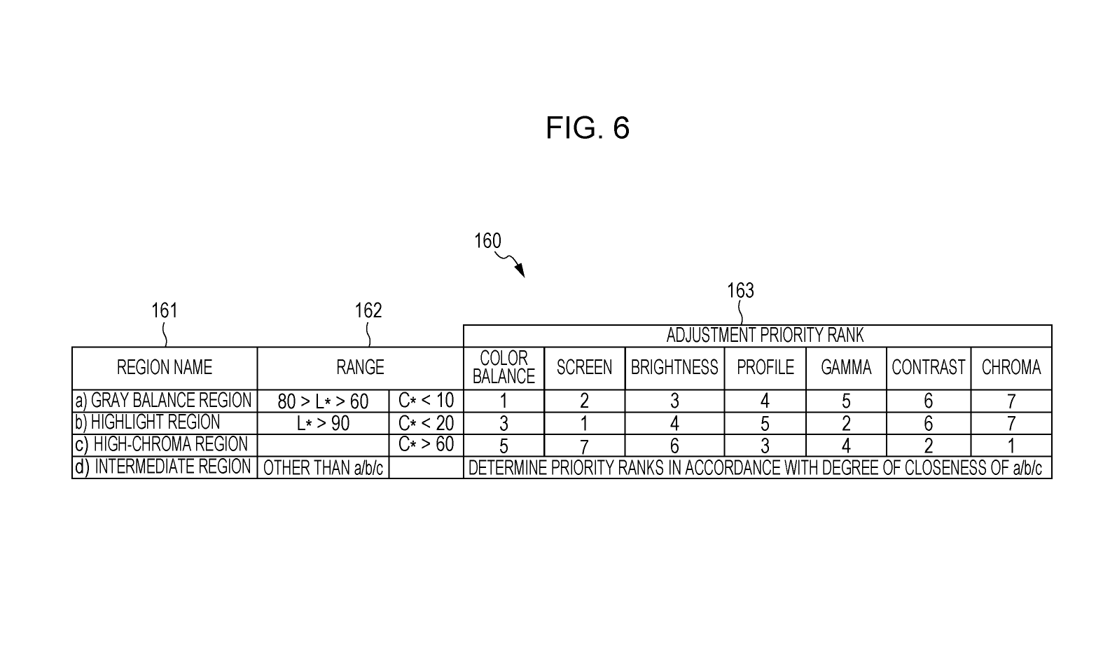

FIG. 6 is a diagram illustrating an example of the priority-rank database 160.

In the example illustrated in FIG. 6, the characteristics (brightness and chroma) of images are classified into four regions indicated in a region name column 161 and registered in the priority-rank database 160. In addition, the ranges of the brightness and chroma of each region are registered in a range column 162. For example, for a gray balance region, a brightness value is in the range of greater than 60 and less than 80, and a chroma value is in the range of less than 10.

The priority ranks of adjustment processes are associated with the characteristics of the images classified into the regions in this manner, and are registered in a priority-rank column 163. The priority ranks of adjustment processes of seven types are registered in the example illustrated in FIG. 6. For example, the characteristics of an image classified into the gray balance region is associated with the first rank for color balance adjustment, the second rank for screen selection, the third rank for brightness adjustment, the fourth rank for profile selection, the fifth rank for gamma correction, the sixth rank for contrast adjustment, and the seventh rank for chroma adjustment. Note that the priority-rank column 163 is a column in which priority ranks considered to be appropriate in accordance with an empirical rule regarding the characteristics of images. However, the example of FIG. 6 is an example for illustrating a method for associating priority ranks with the characteristics of images, and the priority ranks are not necessarily appropriate in the example. An example of appropriate priority ranks will be described later.

By verifying the characteristics of the document image acquired through analysis performed by the data analysis unit 151 against the ranges registered in the range column 162, the priority-rank determination unit 152 classifies the characteristics of the document image into one of the four regions indicated in the region name column 161. The priority-rank determination unit 152 determines, to be the priority ranks of the adjustment processes corresponding to the document image to be adjusted, the priority ranks that are associated with the region into which the characteristics of the image are classified and that are registered in the priority-rank column 163.

The input-screen display unit 153 illustrated in FIG. 4 causes, in accordance with the priority ranks determined by the priority-rank determination unit 152, input screens for inputting adjustment details of the adjustment processes to be displayed on the display 102. In the present exemplary embodiment, input screens are prepared for seven respective types of adjustment process, each input screen being a screen for inputting adjustment details of a corresponding one of the seven types of adjustment process. These input screens are sequentially displayed in accordance with the priority ranks. Each input screen corresponds to an example of an operation screen according to the exemplary embodiment of the present invention. In the following, the input screens for the seven respective types of adjustment process will be described.

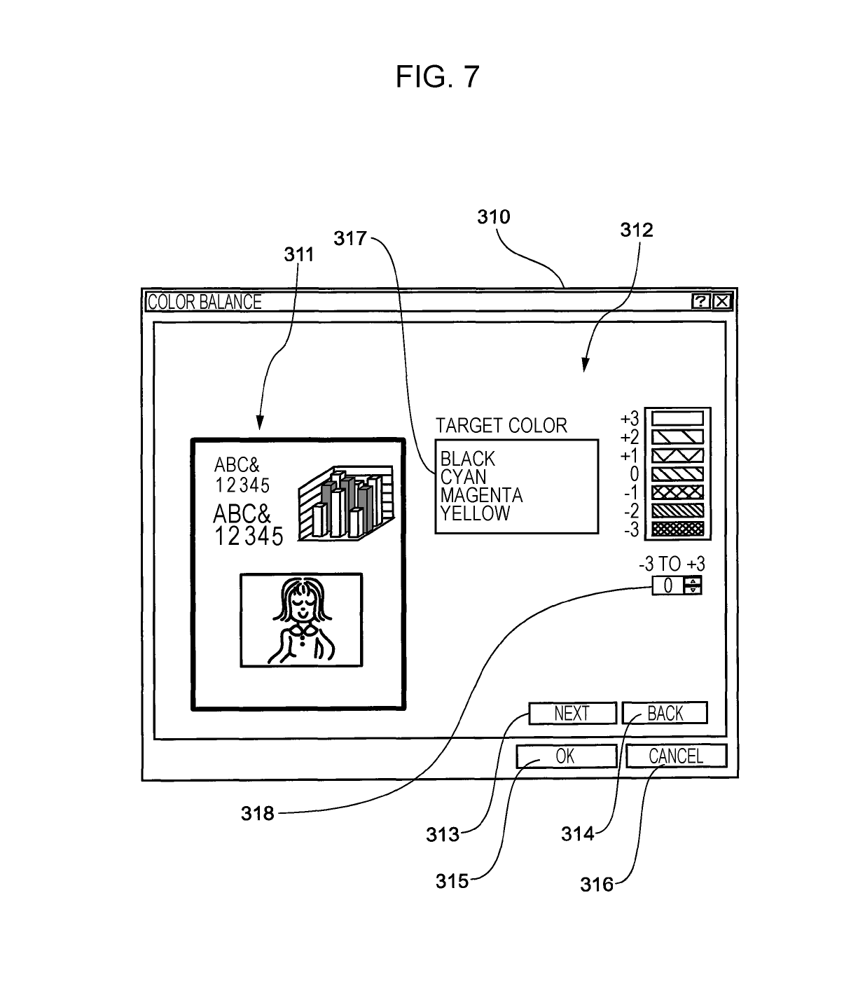

FIG. 7 is a diagram illustrating an input screen 310 for color balance adjustment.

The input screen 310 for color balance adjustment has a preview field 311 and an adjustment field 312.

The preview field 311 displays a reduced version of a document image to be adjusted, and adjustment details input by a user operating the adjustment field 312 are reflected in the document image displayed in the preview field 311.

The adjustment field 312 of the input screen 310 for color balance adjustment has a selection field 317 for selecting a process color whose balance is to be changed from among four process colors (black, cyan, magenta, and yellow), and an increment-decrement field 318 for specifying an increment or a decrement of the process color within a range of from −3 to +3.

In addition, the input screen 310 for color balance adjustment has a “next” button 313, a “back” button 314, an OK button 315, and a cancel button 316.

When the “next” button 313 is operated, the adjustment details input in the adjustment field 312 are confirmed, and the displayed screen is changed to the input screen for the next adjustment process according to the above-described priority ranks. In contrast, when the “back” button 314 is operated, the adjustment details input in the adjustment field 312 are canceled, and the displayed screen is changed to the input screen for the previous adjustment process according to the priority ranks.

When the OK button 315 is operated, the adjustment processes end with the image quality adjustments performed so far, and when the cancel button 316 is operated, all of the image quality adjustments are canceled and the document image returns to the initial document image.

The configuration of the input screen 310 for color balance adjustment is common to the configurations of input screens for the other six types of adjustment process except for the adjustment field 312.

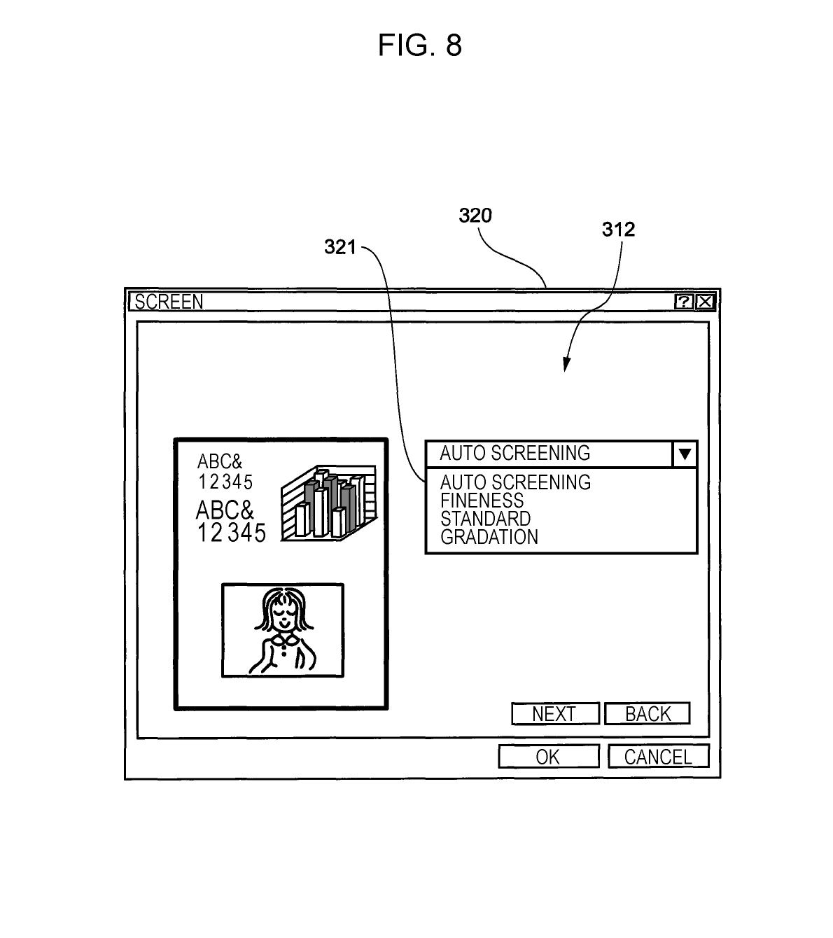

FIG. 8 is a diagram illustrating an input screen 320 for screen selection.

An adjustment field 312 of the input screen 320 for screen selection has a screen selection field 321. The screen selection field 321 is a so-called drop-down list, and a screen pattern is selected by selecting one of screen pattern names arranged in the list.

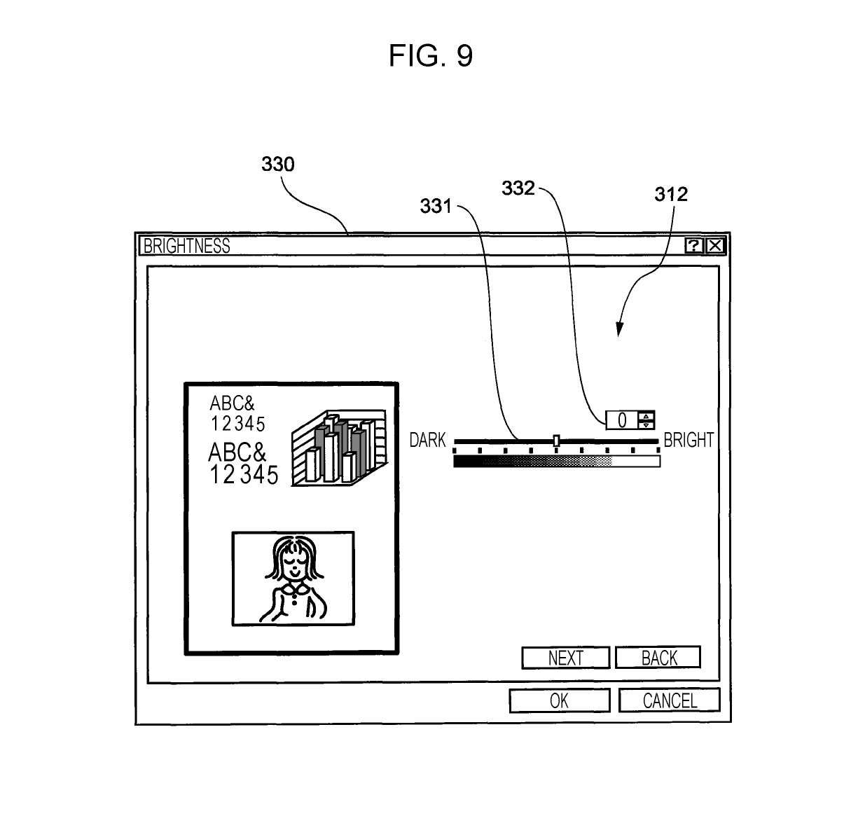

FIG. 9 is a diagram illustrating an input screen 330 for brightness adjustment.

An adjustment field 312 of the input screen 330 for brightness adjustment has a slide bar 331 and an adjustment-value field 332. When the slide bar 331 is operated, a brightness adjustment value is displayed in the adjustment-value field 332. A brightness adjustment value may also directly and manually be input to the adjustment-value field 332.

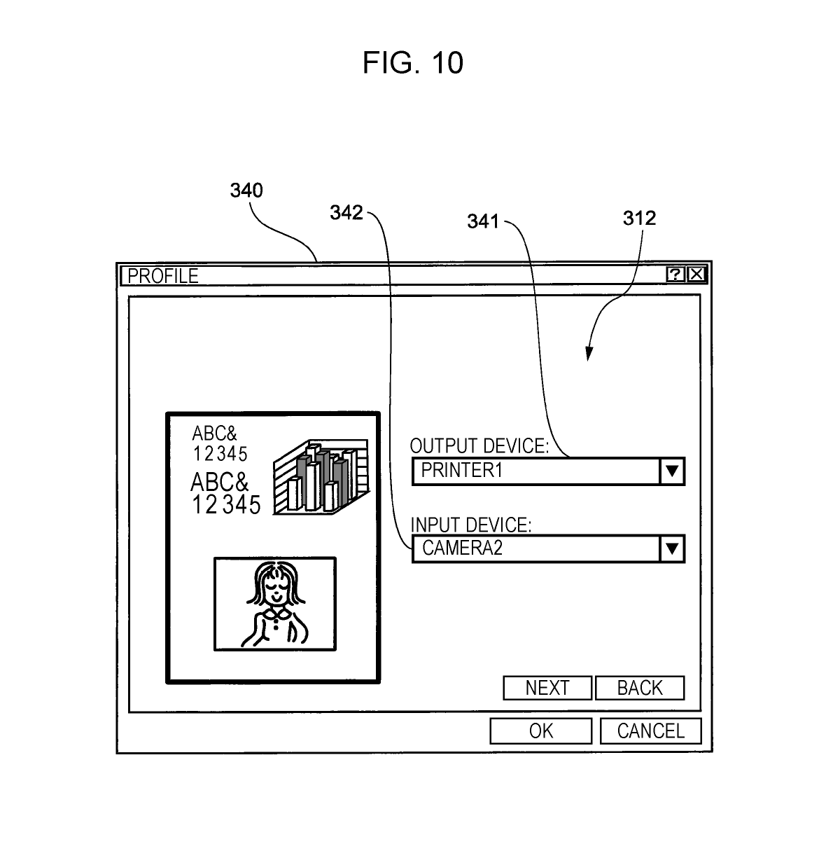

FIG. 10 is a diagram illustrating an input screen 340 for profile selection.

An adjustment field 312 of the input screen 340 for profile selection has an output profile selection field 341 and an input profile selection field 342. These selection fields are so-called drop-down lists. For each of the selection fields, one of profile names arranged in the list is selected.

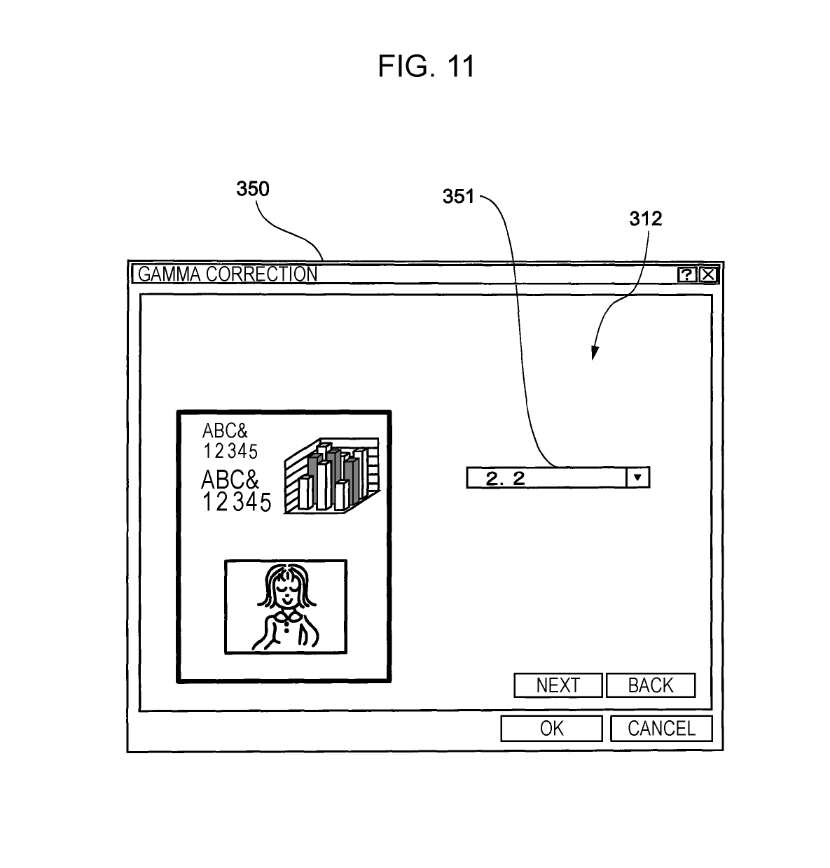

FIG. 11 is a diagram illustrating an input screen 350 for gamma correction.

An adjustment field 312 of the input screen 350 for gamma correction has a gamma-value input field 351. A gamma value is input to the gamma-value input field 351.

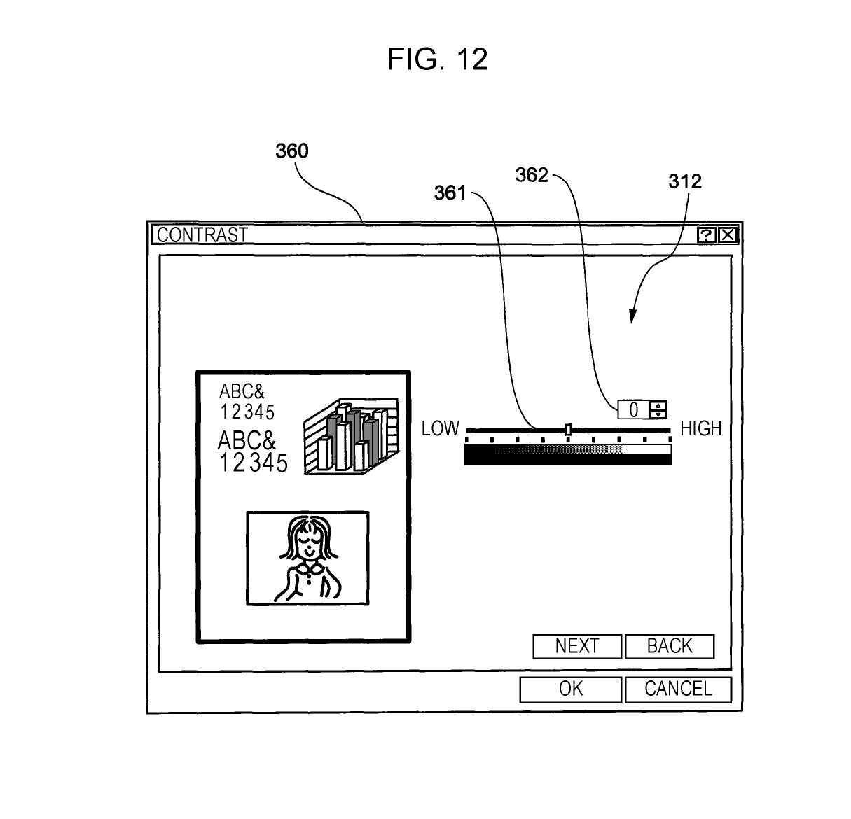

FIG. 12 is a diagram illustrating an input screen 360 for contrast adjustment.

An adjustment field 312 of the input screen 360 for contrast adjustment has a slide bar 361 and an adjustment-value field 362. When the slide bar 361 is operated, a contrast adjustment value is displayed in the adjustment-value field 362. A contrast adjustment value may also directly and manually be input to the adjustment-value field 362.

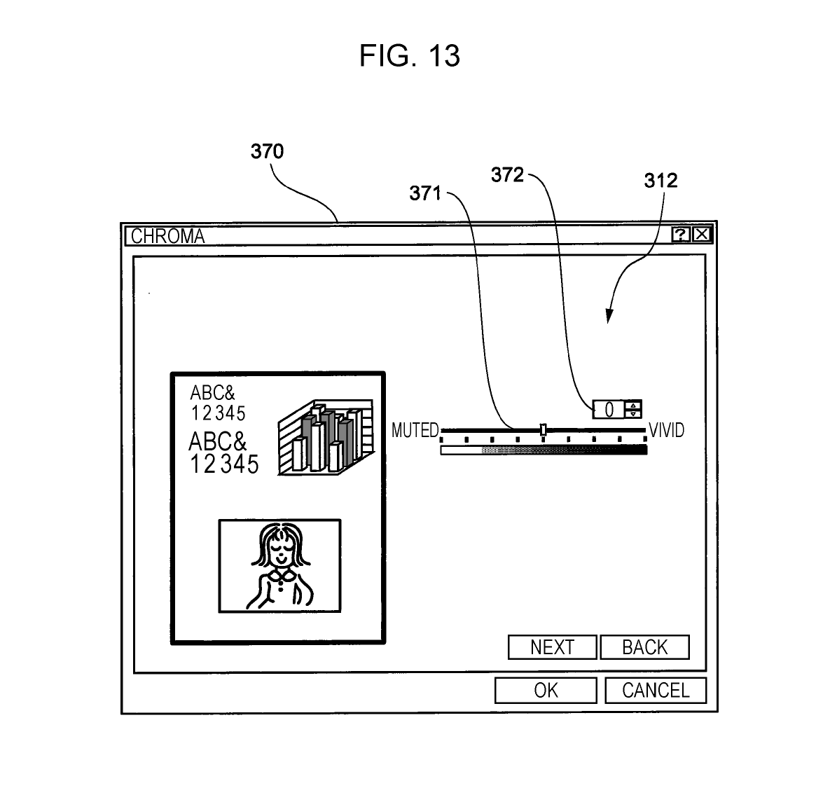

FIG. 13 is a diagram illustrating an input screen 370 for chroma adjustment.

An adjustment field 312 of the input screen 370 for chroma adjustment also has a slide bar 371 and an adjustment-value field 372. When the slide bar 371 is operated, a chroma adjustment value is displayed in the adjustment-value field 372. A chroma adjustment value may also directly and manually be input to the adjustment-value field 372.

When the above-described input screens 310 to 370 are displayed in accordance with the priority ranks on the display 102 by the input-screen display unit 153 illustrated in FIG. 4, adjustment details are input through each input screen by a user operating an input device such as the keyboard 103 or the mouse 104. The adjustment details input in this manner are acquired by the adjustment-detail acquisition unit 154, and adjustment processes are performed on the document image by the image quality adjustment unit 155 in accordance with the adjustment details. In addition, a reduced version of the document image on which the adjustment processes have been performed is displayed in the preview field 311.

The finishing confirmation unit 156 is a unit that confirms finishing or continuation of the image quality adjustment performed through operation of the “next” button 313, the “back” button 314, the OK button 315, and the cancel button 316 of the input screens 310 to 370.

In the case where the “next” button 313 is operated, the finishing confirmation unit 156 instructs the input-screen display unit 153 to display the input screen for the next adjustment process according to the priority ranks.

In the case where the “back” button 314 is operated, the finishing confirmation unit 156 instructs the input-screen display unit 153 to display the input screen for the previous adjustment process according to the priority ranks, and instructs the image quality adjustment unit 155 to cancel the adjustment process based on the adjustment details input through the currently displayed input screen.

In the case where the cancel button 316 is operated, the finishing confirmation unit 156 instructs the input-screen display unit 153 to display the input screen for the first adjustment process according to the priority ranks, and instructs the image quality adjustment unit 155 to cancel all the adjustment processes that have been performed so far.

In the case where the OK button 315 is operated, the finishing confirmation unit 156 recognizes finishing of the image quality adjustment, and outputs image data 220 representing the document image on which certain adjustment process or processes have been performed by the image quality adjustment unit 155.

A combination of the adjustment-detail acquisition unit 154 and the image quality adjustment unit 155 corresponds to an example of an adjustment unit according to the exemplary embodiment of the present invention, and a combination of the data analysis unit 151, the priority-rank determination unit 152, and the input-screen display unit 153 corresponds to an example of an order controller according to the exemplary embodiment of the present invention.

Here, an example of an appropriate order of adjustment processes will be described.

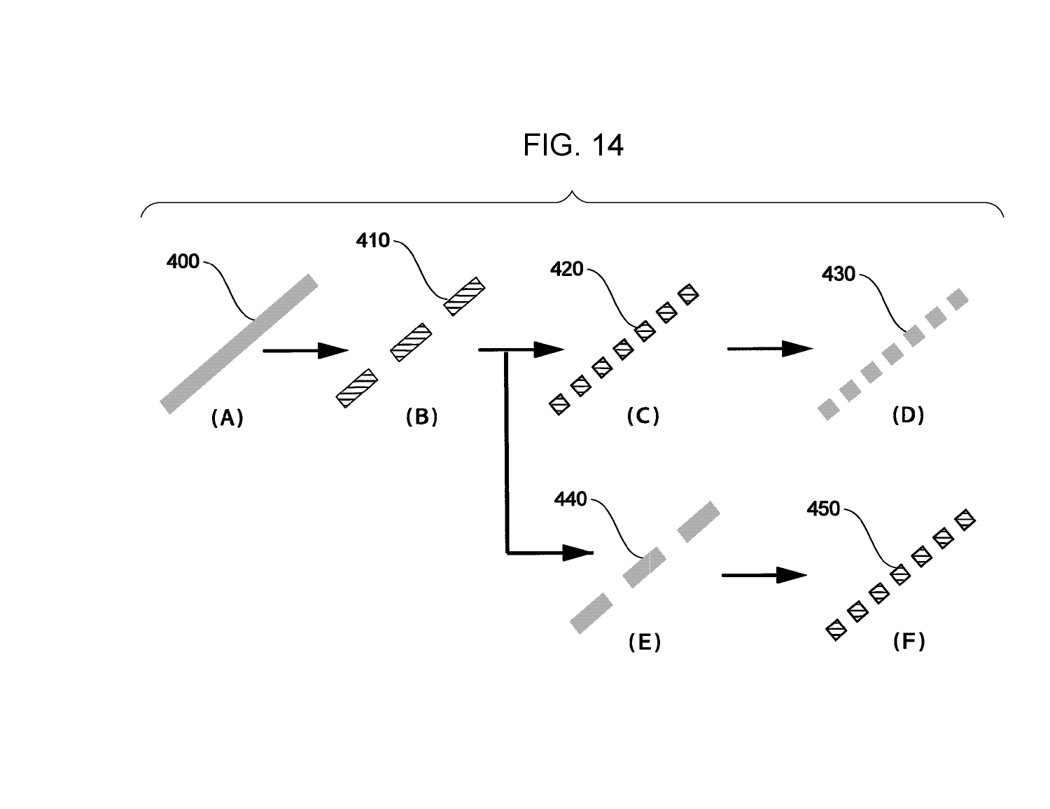

FIG. 14 is a diagram illustrating an example of an appropriate order of adjustment processes.

Here, a gray fine line 400 is illustrated in part A of FIG. 14 as an example of an image. The image quality of such an image may change due to, for example, the effect of conversion of data for print, the conversion being performed by the data conversion function 132 illustrated in FIG. 3, or due to the effect of application of image data for another print system to the print system 1 illustrated in FIG. 1. For example, part B of FIG. 14 illustrates as an example a line 410 that is broken and more yellow tinted due to such an effect. The image quality adjustment apparatus 150 illustrated in FIG. 5 performs adjustment processes to make this changed image quality be close to the original image quality.

Part C and part D of FIG. 14 illustrate, as an example of an appropriate order of processes, an example in which color balance adjustment is performed after screen selection. By changing the current screen to a screen having a greater number of lines in screen selection, a fine line 420 with improved brokenness is acquired as illustrated in part C of FIG. 14. Thereafter, a gray fine line 430 with an improved tint is acquired by reducing the density of yellow in color balance adjustment as illustrated in part D of FIG. 14.

In contrast, part E and part F of FIG. 14 illustrate an example in which screen selection is performed after color balance adjustment. By reducing the density of yellow in color balance adjustment, a gray fine line 440 that is broken as illustrated in part E of FIG. 14 is acquired. Thereafter, when the current screen is changed to a screen having a greater number of lines in screen selection, a fine line 450 with improved brokenness but having a color balance shifted from gray is acquired as illustrated in part F of FIG. 14.

Such a shift in color balance is caused by tone characteristics that differ from screen pattern to screen pattern in a printer.

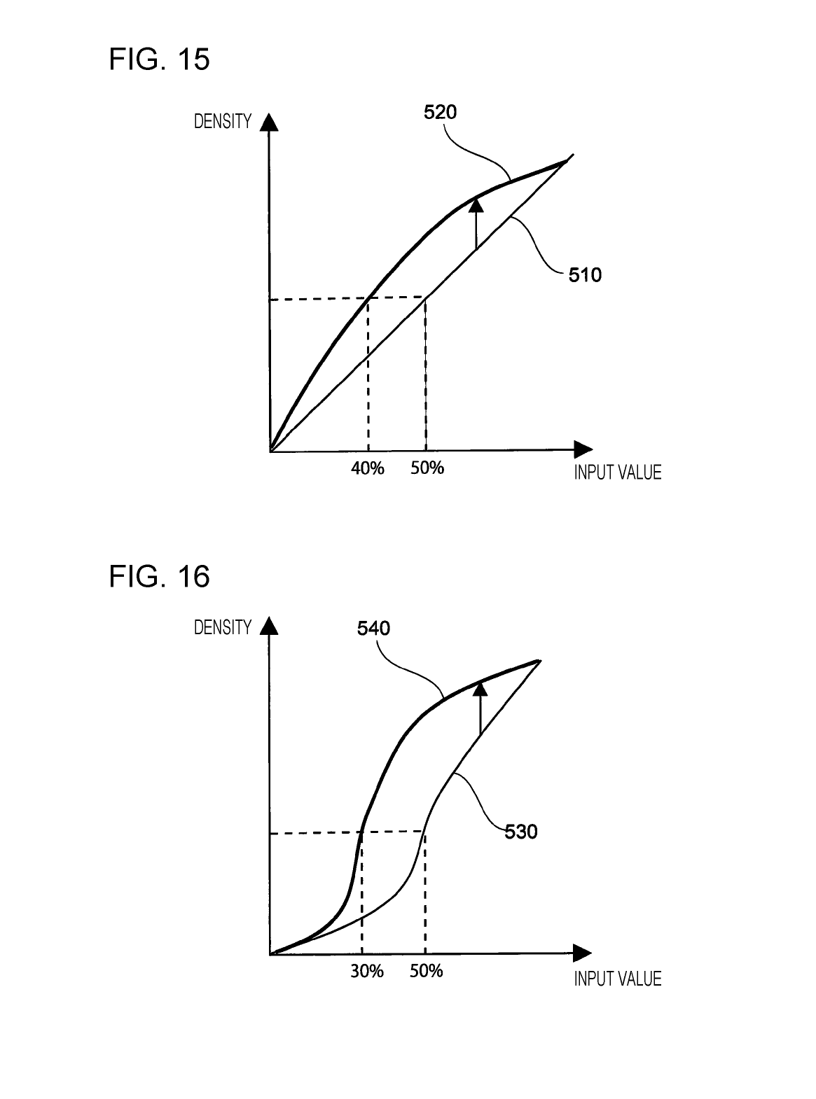

FIG. 15 is a graph illustrating an example of tone characteristics in a screen pattern having a low number of lines, and FIG. 16 is a graph illustrating an example of tone characteristics in a screen pattern having a high number of lines.

The horizontal axes of the graphs of FIGS. 15 and 16 represent dot percent, input values, and the vertical axes represent output density values.

A fine line 510 in the graph of FIG. 15 represents tone characteristics acquired when the gray fine line 400 illustrated in part A of FIG. 14 is acquired, and a thick line 520 in the graph represents tone characteristics acquired when the line 410 illustrated in part B of FIG. 14 is acquired. An input value is corrected to correct a shift in color balance caused by changes in such tone characteristics, and for example an input value is corrected to 40% in order to realize gray 50% in color balance in part E of FIG. 14.

In contrast, a thick line 540 in the graph illustrated in FIG. 16 represents tone characteristics acquired when the fine line 420 illustrated in part C of FIG. 14 is acquired, and a fine line 530 in the graph represents tone characteristics acquired in a state in which good color balance is achieved. An input value needs to be corrected to 30% in order to correct a shift in color balance caused by changes in such tone characteristics and realize, for example, gray 50% in color balance.

The color balance is corrected through such input-value correction in part D of FIG. 14. However, when the screen pattern is changed from that for part E of FIG. 14, in which the input value is corrected to 40%, to that for part F of FIG. 14, the amount of correction in the input value becomes insufficient and the color balance is not maintained.

In this manner, an appropriate order exists for order of the adjustment processes; however, it is empirically or analytically known that such an appropriate adjustment order differs depending on characteristics of an image to be adjusted such as whether the image is an image in a gray region or an image in a high-chroma region. In the present exemplary embodiment, such an appropriate order serving as priority ranks is associated with the characteristics of an image and stored in the priority-rank database 160 as described above.

Note that the example in which the input screens 310 to 370 are sequentially displayed each of which is an input screen for a corresponding type of adjustment process is described in the above-described exemplary embodiment; however, there may be the following other examples of the operation-screen display method according to the exemplary embodiment of the present invention.

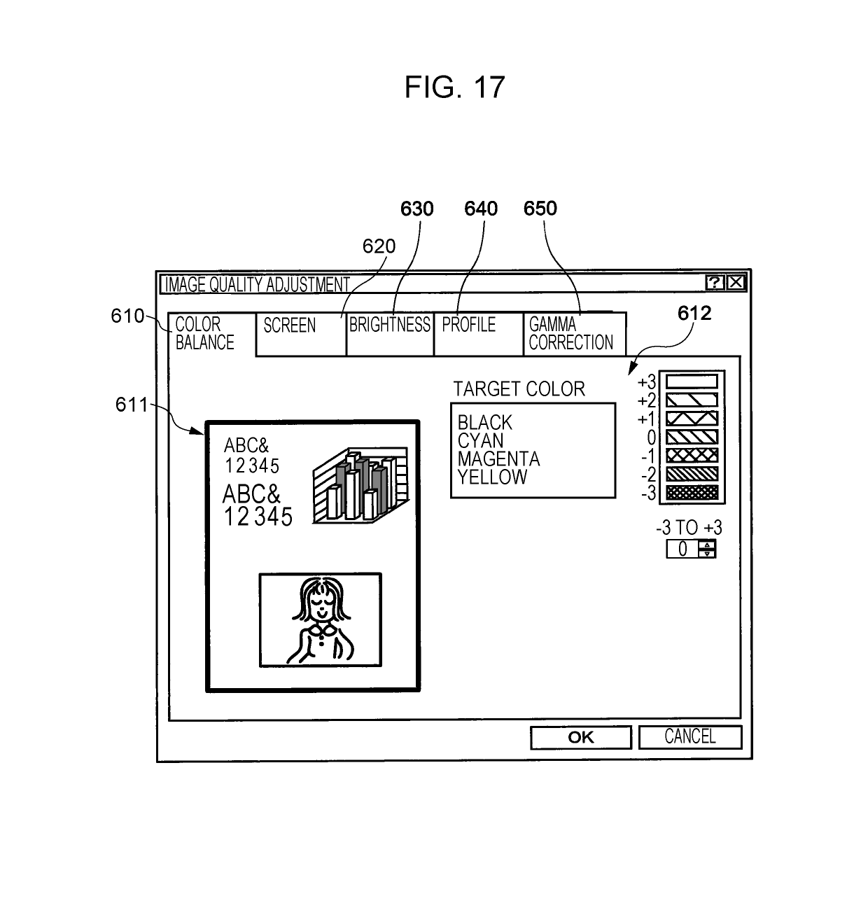

FIG. 17 is a diagram illustrating another example (hereinafter referred to as first example) of the operation screen according to the exemplary embodiment of present invention.

In the first example, similarly to the above-described input screens 310 to 370, multiple input screens 610 to 650 having a preview field 611 and an adjustment field 612 are displayed in a state in which the multiple input screens 610 to 650 overlap with each other. The order in which the input screens 610 to 650 overlap with each other is order of the above-described priority ranks. In addition, the input screens 610 to 650 for the adjustment processes having the top five ranks among the adjustment processes of the seven types are displayed in the first example. All the adjustment processes are not always necessary to acquire desired image quality. By omitting display of adjustment processes having low priority ranks, only necessary adjustment processes are displayed.

Tabs that are portions protruding upward from the input screens 610 to 650 do not overlap with each other, and the priority ranks are recognized from the arrangement of these tabs. In addition, a corresponding type of adjustment processes is selected by clicking one of the tabs.

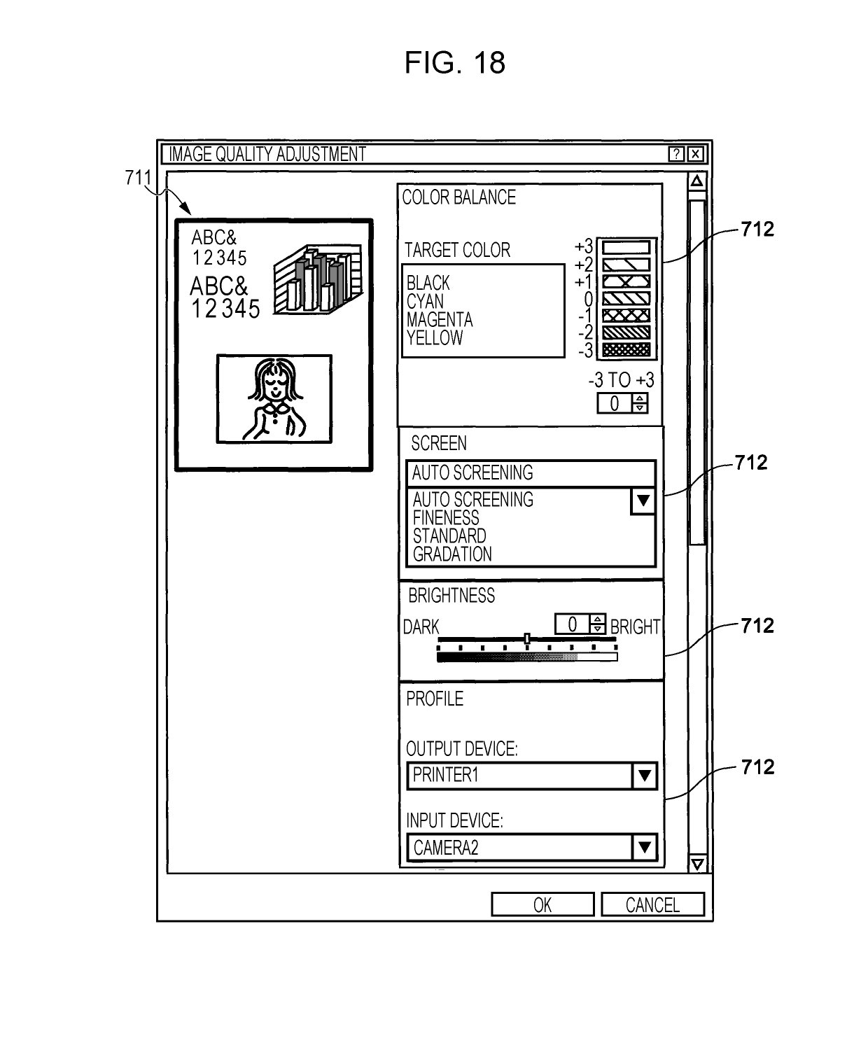

FIG. 18 is a diagram illustrating another example (hereinafter referred to as second example) of the operation screen according to the exemplary embodiment of present invention.

In the second example, for one preview 711, multiple adjustment fields 712 are arranged and displayed. The order in which the adjustment fields 712 are arranged is order of the above-described priority ranks, and the priority ranks are recognized from the arrangement of the adjustment fields 712. In the second example, each of the adjustment fields 712 corresponds to an example of the operation screen according to the exemplary embodiment of the present invention.

Note that the above-described exemplary embodiment is an example in which the image quality adjustment apparatus 150 is installed in the print system 1 in which images are printed by the printer 20. However, the image quality adjustment apparatus 150 according to the exemplary embodiment of the present invention may be installed in a printing system in which images are printed by a printing machine, or a display system in which images are displayed by a display or a projector, and may also be a single image quality adjustment apparatus that is not installed in any system.

In addition, the above-described exemplary embodiment is an example in which the functions are realized by an information processing apparatus and by a program; however, the functions of the image quality adjustment apparatus 150 according to the exemplary embodiment of the present invention may also be realized by a hardware circuit or circuits.

In addition, in the above-described exemplary embodiment, “image quality” refers to the quality of an image, and is determined considering all of the colors, contrast, noise, and pixel density of the image. The image quality is not limited to the above-described characteristics of the image. In addition, “adjustment processes” refer to various types of process performance of which results in image quality adjustment. Adjustment processes may also be for example color adjustment, gamma adjustment, profile selection, and screen selection, and are not limited to these.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image quality adjustment apparatus comprising:
an adjustment unit that sequentially receives instructions of adjustment details for adjustment processes of a plurality of types for adjusting image quality, and sequentially performs the adjustment processes on an image; and
an order controller that presents, in accordance with priority ranks that have been associated in advance with characteristics of an image to be processed, operation screens for receiving instruction operations for the adjustment details.

2. The image quality adjustment apparatus according to claim 1, wherein the order controller acquires the characteristics from the entirety of the image to be processed.

3. The image quality adjustment apparatus according to claim 1, wherein the order controller acquires the characteristics from an image object selected from among image objects constituting the image to be processed.

4. The image quality adjustment apparatus according to claim 1, wherein the order controller acquires the characteristics from a region selected in the image to be processed.

5. The image quality adjustment apparatus according to claim 1, wherein the order controller uses, as the characteristics, characteristics based on at least one of brightness and chroma of the image as a standard.

6. The image quality adjustment apparatus according to claim 2, wherein the order controller uses, as the characteristics, characteristics based on at least one of brightness and chroma of the image as a standard.

7. The image quality adjustment apparatus according to claim 3, wherein the order controller uses, as the characteristics, characteristics based on at least one of brightness and chroma of the image as a standard.

8. The image quality adjustment apparatus according to claim 4, wherein the order controller uses, as the characteristics, characteristics based on at least one of brightness and chroma of the image as a standard.

9. The image quality adjustment apparatus according to claim 1, wherein the order controller causes, among the adjustment processes of the plurality of types, some adjustment processes having high ranks among the priority ranks to be executed.

10. The image quality adjustment apparatus according to claim 2, wherein the order controller causes, among the adjustment processes of the plurality of types, some adjustment processes having high ranks among the priority ranks to be executed.

11. The image quality adjustment apparatus according to claim 3, wherein the order controller causes, among the adjustment processes of the plurality of types, some adjustment processes having high ranks among the priority ranks to be executed.

12. The image quality adjustment apparatus according to claim 4, wherein the order controller causes, among the adjustment processes of the plurality of types, some adjustment processes having high ranks among the priority ranks to be executed.

13. The image quality adjustment apparatus according to claim 5, wherein the order controller causes, among the adjustment processes of the plurality of types, some adjustment processes having high ranks among the priority ranks to be executed.

14. The image quality adjustment apparatus according to claim 6, wherein the order controller causes, among the adjustment processes of the plurality of types, some adjustment processes having high ranks among the priority ranks to be executed.

15. The image quality adjustment apparatus according to claim 7, wherein the order controller causes, among the adjustment processes of the plurality of types, some adjustment processes having high ranks among the priority ranks to be executed.

16. The image quality adjustment apparatus according to claim 1, wherein the order controller sequentially displays the operation screens in an order based on the priority ranks.

17. The image quality adjustment apparatus according to claim 1, wherein the order controller displays the operation screens such that the operation screens overlap with each other in an order based on the priority ranks.

18. The image quality adjustment apparatus according to claim 1, wherein the order controller displays the operation screens such that the operation screens are arranged in an order based on the priority ranks.

19. An image quality adjustment method comprising:
sequentially receiving instructions of adjustment details for adjustment processes of a plurality of types for adjusting image quality, and sequentially performing the adjustment processes on an image; and
presenting, in accordance with priority ranks that have been associated in advance with characteristics of an image to be processed, operation screens for receiving instruction operations for the adjustment details.

20. A non-transitory computer readable medium storing a program causing a computer to execute a process, the process comprising:
sequentially receiving instructions of adjustment details for adjustment processes of a plurality of types for adjusting image quality, and sequentially performing the adjustment processes on an image; and
presenting, in accordance with priority ranks that have been associated in advance with characteristics of an image to be processed, operation screens for receiving instruction operations for the adjustment details.
